(19) United States
(12) Patent Application Publication
(10) Pub. No.: US 2005/0286803 A1
(43) Pub. Date: Dec. 29, 2005

(54) Image processing apparatus, display device, image processing method, and image processing program

(75) Inventor: Masaomi Satake, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/165,604

(22) Filed: Jun. 23, 2005

(30) Foreign Application Priority Data
Jun. 25, 2004 (JP) P.2004-187275

(51) Int. Cl. G06K 9/32; G06K 9/36

(52) U.S. Cl. 382/299; 382/233

(57) ABSTRACT

An image processing apparatus includes a calculation section which calculates a reduced size of an image to be decoded based on an image size of the image to be decoded and an altered image size for displaying in a reduced size, a decoding section which decodes image data of the image to be decoded to generate decoded image data, a memory which stores display image data, and a reduction section which extracts only pixel data required for displaying in the reduced size from the decoded image data generated by the decoding section, based on the calculated reduced size, and writes the extracted pixel data to the memory.

### CROSS-REFERENCE TO RELATED APPLICATIONS

This application is based upon and claims the benefit of priority from the prior Japanese Patent Applications No. 2004-187275 filed on Jun. 25, 2004, the entire contents of which are incorporated herein by reference.

### BACKGROUND OF THE INVENTION

1. Field of the Invention

The present invention relates to an image processing apparatus which decodes image data and performs a compression processing for the image data, a display device, and an image processing method and an image processing-program.

2. Description of the Related Art

Portable terminals, such as cellular phones and PDAs (Personal Digital Assistants), have a function whereby images are taken by an incorporated camera, or are received via a network, and then JPEG (Joint Photographic Experts Group) standard encoded (compressed) image data are decoded and displayed on a display section.

In order to cope with a situation wherein the size of the encoded image data differs from the display size of the display section, the portable terminal decodes all the encoded image data and temporarily stores it, and thereafter, reads the image data from the memory, reduces the size of the image data to that for the display, and displays the image data on the display section. For example, when the imaging size of a camera provided for a cellular phone is 960×1280 pixels and the maximum display size for a display section that is provided is 240×320 pixels, in order to display, on the display section, image data that have been obtained at 960×1280 pixels and encoded and stored in memory, the encoded image data for the 960×1280 pixels are decoded and the decoded data are stored in the memory. Thereafter, the decoded image data are read from the memory as display image data for 240×320 pixels. In this case, the cellular phone requires a memory capacity of about 3.5 MB to store the decoded image data for 960×1280 pixels, since three bytes are required for each pixel. Further, based on these decoded image data, a memory capacity of about 230 KB is required to store display image data for 240×320 pixels. JP-UM-A-7-11069 is referred to as a related art and discloses a portable apparatus that can transmit JPEG standard encoded image data to a remote area.

However, additional requirements demanded for the portable terminal are that the scale and the cost should be reduced by using memory efficiently.

### SUMMARY OF THE INVENTION

An object of the invention is to provide an image processing apparatus, wherein the memory capacity required for a display processing for image data can be reduced when the size of the image data to be decoded differs from a display size, a display device, an image processing method and an image processing program.

The invention provides an image processing apparatus, having: a calculation section which calculates a reduced size of an image to be decoded, based on an image size of the image to be decoded and an altered image size for displaying in a reduced size; a decoding section which decodes image data of the image to be decoded to generate decoded image data; a memory which stores display image data; and a reduction section which extracts only pixel data required for displaying in the reduced size from the decoded image data generated by the decoding section, based on the calculated reduced size, and writes the extracted pixel data to the memory.

The invention also provides a display device, having: a calculation section which calculates a reduced size of an image to be decoded, based on an image size of the image to be decoded and an altered image size for displaying in a reduced size; a decoding section which decodes image data of the image to be decoded to generate decoded image data; a memory which stores display image data; a reduction section, which extracts only those pixel data required for displaying in the reduced size from the decoded image data generated by the decoding section, based on the calculated reduced size, and writes the extracted pixel data to the memory; and a display section which displays an image based on the pixel data written to the memory.

The invention also provides an image processing method, including the steps of: calculating a reduced size of an image to be decoded, based on an image size of the image to be decoded and an altered image size for displaying in a reduced size; decoding image data of the image to be decoded to generate decoded image data; and extracting only pixel data required for displaying in the reduced size from the decoded image data, based on the calculated reduced size, and writing the extracted pixel data to a memory.

The invention also provides an image processing program, causing a computer to perform: a function of calculating a reduced size of an image to be decoded, based on an image size of the image to be decoded and an altered image size for displaying in a reduced size; a function of decoding image data of the image to be decoded to generate decoded image data; and a function of extracting only pixel data required for displaying in the reduced size from the decoded image data, based on the calculated reduced size, and writing the extracted pixel data to a memory.

According to the an image processing apparatus, the display device, the image processing method, and the image processing program, the capacity of the memory required for displaying the image can be reduced, even if the image size of the image to be decoded differs from the display size.

### BRIEF DESCRIPTION OF THE DRAWINGS

FIG. 1 is a diagram showing the configuration of an image processing apparatus according to an embodiment of the present invention.

FIGS. 2A and 2B are diagrams respectively showing the size of image data D_in and the display size of a display section.

FIG. 3 is a flowchart for explaining the processing performed by a reduced frame calculator, a sub-sampling section and a controller in an example operation performed by an image processing apparatus in FIG. 1.

FIG. 4 is a flowchart for explaining the processing at step ST6 in FIG. 3.

FIG. 5 is a flowchart for explaining another processing for step ST6 in FIG. 3.

### DETAILED DESCRIPTION OF THE PREFERRED EMBODIMENTS

An embodiment of the present invention will now be described while referring to the accompanying drawings.

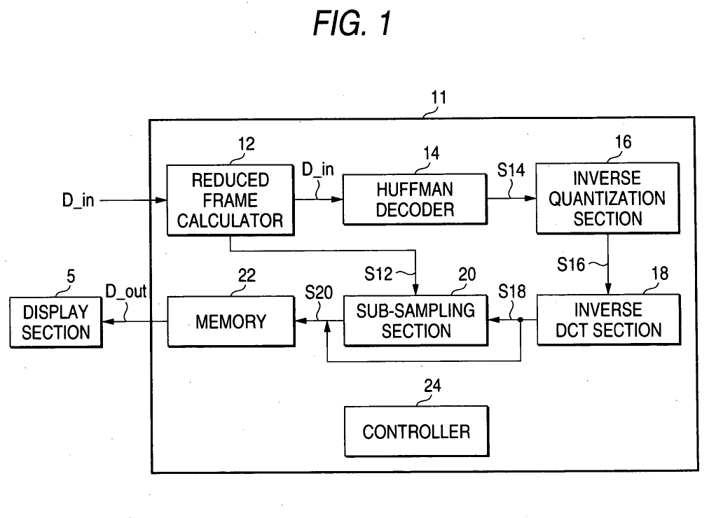

FIG. 1 is a diagram showing the configuration of an image processing apparatus 11 according to an embodiment of the present invention. As shown in FIG. 1, the image processing apparatus 11 has a reduced frame calculator 12, a Huffman decoder 14, an inverse quantization section 16, an inverse DCT (Discrete Cosine Transform) section 18, a sub-sampling section 20, a memory 22, and a controller 24. The reduced frame calculator 12, the Huffman decoder 14, the inverse quantization section 16, the inverse DCT section 18, the sub-sampling section 20, the memory 22, and the controller 24 are provided, for example, by software or electronic circuits.

The image processing apparatus 11 is built into a portable terminal such as a cellular phone or a PDA, and the portable terminal includes a display section 5 having a display size “Dst_h×Dst_w” (vertical×horizontal).

The image processing apparatus 11 decodes input image data D_in (image data to be decoded) having an Src_h×Src_w (vertical×horizontal) size, and reduces the decoded image data (performs sampling only for required pixels) so that it fits the display size of the display section 5. Thereafter, the image processing apparatus 11 generates reduced image data S20 and stores the reduced image data S20 in the memory 22. That is, the image processing apparatus 11 does not write to the memory 22 all decoded image data S18 that have been output by the inverse DCT section 18, but writes to the memory 22 the reduced image data S20 obtained by sampling only the required pixels in the decoded image data S18. In this embodiment, the image data D_in are, for example, still image data encoded (compressed) using the JPEG standards.

The image data D_in may, for example, be moving image data encoded (compressed) using MPEG (Moving Picture Experts Group) standards. The individual components of the image processing apparatus 11 in FIG. 1 will now be described.

[Reduced Frame Calculator 12]

The reduced frame calculator 12 receives image data D_in such as image data that the portable terminal has received via a network, or image data that are obtained by the camera provided for the portable terminal.

Based on the size of the image data D_in, and the altered image size (hereinafter referred to as a reduced frame) instructed by a higher application layer for the reduced size display, the reduced frame calculator 12 re-calculates a reduction frame for the actual reduced size display.

It should be noted that the reduced frame calculator 12 re-calculates the reduced frame, so that image data can be fitted into the display size with maintaining the aspect ratio of an image to be displayed based on the image data D_in.

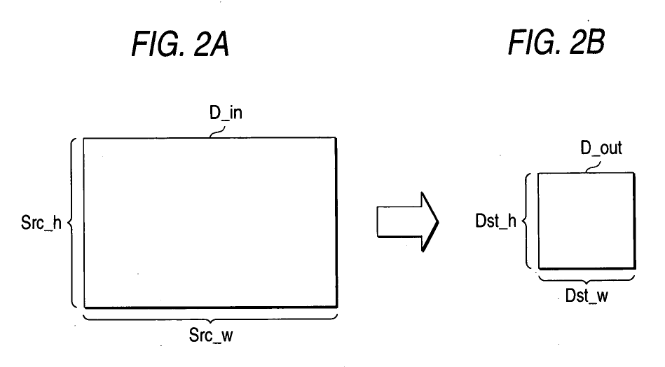

When the size of the image data D_in are “Src_h×Src_w” (vertical×horizontal), as shown in FIG. 2A, and the display size is “Dst_h×Dst_w” (vertical×horizontal), as shown in FIG. 2B, and when “(Src_w/Dst_w)>(Src_h/Dst_h)” has been established, the reduced frame calculator 12 calculates “Src_h×(Dst_w/Src_w)” and obtains data “Dst_ha” as the result.

On the other hand, when “(Src_w/Dst_w)>(Src_h/Dst_h)” has not been established, the reduced frame calculator 12 calculates “Src_w×(Dst_h/Src_h)” and obtains data “Dst_wa” as the result.

That is, the reduced frame calculator 1 re-calculates the size of image data D_out that are to be displayed, while maintaining the aspect ratio of an image that is to be displayed based on the image data D_in.

[Huffman Decoder 14]

The Huffman decoder 14 decodes the image data D_in as Huffman codes, generates image data S14, and outputs the image data S14 to the inverse quantization section 16.

[Inverse Quantization Section 16]

The inverse quantization section 16 performs the inverse quantization of the image data S14 received from the Huffman decoder 14, generates image data S16, and outputs the image data S16 to the inverse DCT section 18.

[Inverse DCT Section 18]

The inverse DCT section 18 performs the inverse DCT processing for the image data S16 received from the inverse quantization section 16 to generate decoded image data S18, and outputs the decoded image data S18 to the sub-sampling section 20.

In this embodiment, this decoding processing is performed for each data MCU (Minimum Coded Unit) of 8×8 pixels.

[Sub-Sampling Section 20]

Based on the data S12 received from the reduced frame calculator 12, the sub-sampling section 20 performs sub-sampling to reduce the size “Src_h×Src_w” (vertical×horizontal) of the decoded image data S18 to the size “Dst_ha×Dst_w” or “Dst_h×Dst wa” (vertical×horizontal) to generate reduced image data S20, and stores the reduced image data S20 in the memory 22. Specifically, based on the data S12, the sub-sampling section 20 selects (sub-sampling), from pixel data composed of the decoded image data S18 received from the inverse DCT section 18, pixel data (valid pixel data) that are valid data for forming the reduced image data S20 having the size “Dst_ha×Dst_w” or “Dst_h×Dst_wa” (vertical×horizontal), generates the reduced image data S20, and stores these data S20 in the memory 22.

That is, the sub-sampling section 20 does not select (that is, not extract), from pixel data composed of the decoded image data S18, pixel data (invalid pixel data) that are not required to form the reduced size image data S20 having the size “Dst_ha×Dst_w” or “Dst_h×Dst_wa” (vertical×horizontal).

[Controller 24]

The controller 24 totally controls the operation of the image processing apparatus 11.

The image processing apparatus 11 reads the reduced image data S20 stored in the memory 22 as display image data D_out, for example, and outputs the data to the display section 5.

An example operation of the image processing apparatus 11 will now be described.

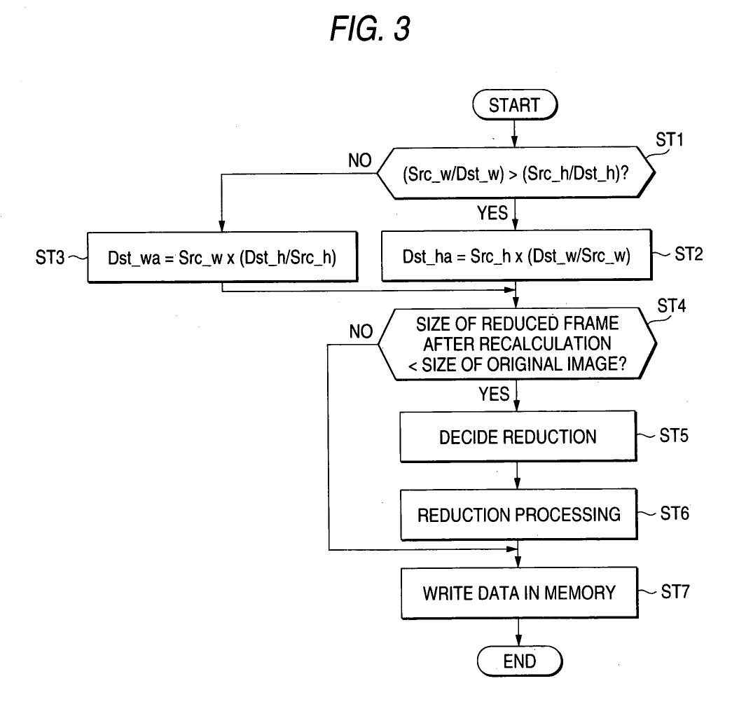

FIG. 3 is a flowchart for explaining the processing performed by the reduced frame calculator 12, the sub-sampling section 20 and the controller 24 in the general operation of the image processing apparatus 11.

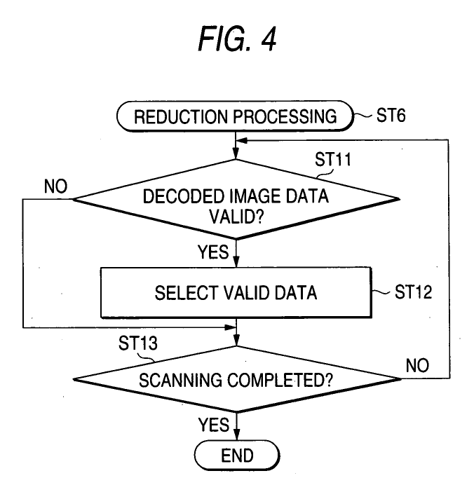

FIG. 4 is a flowchart for explaining the processing at step ST6 in FIG. 3.

First, the reduced frame calculator 12 employs the size “Src_h×Src_w” (vertical×horizontal) of the input image data D_in to determine whether “(Src_w/Dst_w)>(Src_h/Dst_h)” has been established (ST1 in FIG. 3).

When it is determined that “(Src_w/Dst_w)>(Src_h/Dst_h)” has been established, the reduced frame calculator 12 calculates “Src_h×(Dst_w/Src_w)” and obtains data “Dst_ha” (step ST2) as the result.

When it is determined that “(Src_w/Dst_w)>(Src_h/Dst_h)” has not been established, the reduced frame calculator 12 calculates “Src_w×(Dst_h/Src_h)” and obtains data “Dst_wa” (step ST3) as the result.

Then, the reduced frame calculator 12 compares the size of the image data D_in to be decoded with the re-calculated size “Dst_ha×Dst_w” or “Dst_h×Dst wa” (vertical×horizontal) of the image data D_out to be displayed, and determines whether the size of the image data D_in is greater (step ST4).

When the reduced frame calculator 12 determines that the size of the image data D_in is greater, it decides to reduce the size “Src_h×Src_w” (vertical×horizontal) to “Dst_ha×Dst_w” or “Dst_h×Dst wa” (vertical×horizontal), as shown in FIG. 2A, and outputs the data S12 representing this size to the sub-sampling section 20 (step ST5).

When the reduced frame calculator 12 determines that the size of the image data D_in is smaller, it does not perform the succeeding reduction processing.

Following this processing by the reduced frame calculator 12, or parallel to this processing performed by the reduced frame calculator 12, the Huffman decoder 14 decodes the image data D_in as Huffman codes to generate the image data S14, and outputs the image data S14 to the inverse quantization section 16.

Sequentially, the inverse quantization section 16 performs inverse quantization for the image data S14 received from the Huffman decoder 14 to generate the image data S16, and outputs the image data S16 to the inverse DCT section 18.

Next, the inverse DCT section 18 performs the inverse DCT processing for the image data S16 received from the inverse quantization section 16 to generate the decoded image data S18, and outputs the data S18 to the sub-sampling section 20.

Based on the data S12 received by the reduced frame calculator 12, the sub-sampling section 20 selects (sub-sampling) pixel data (valid pixel data) that are valid data for reducing the size “Src_h×Src_w” (vertical×horizontal) for the decoded image data S18 to “Dst_ha×Dst_w” or “Dst_h×Dst_wa” (vertical×horizontal), and generates the reduced image data S20 (step ST6).

Then, the sub-sampling section 20 stores the thus generated reduced image data S20 in the memory 22 (step ST7).

When a reduction is not required, the sub-sampling section 20 stores the decoded image data S18 in the memory 22 without any processing.

At this time, while referring to FIG. 4, based on the data S12, the sub-sampling section 20 determines whether pixel data composed of the decoded image data S18 received from the inverse DCT section 18 are pixel data (valid pixel data) that are valid data for forming the reduced size image data S20 having the size “Dst_ha×Dst_w” or “Dst_h×Dst_w” (vertical×horizontal) (step ST11). When it is determined that pixel data are valid pixel data, the sub-sampling section 20 selects (extracts) these valid pixel data and stores them as the pixel data for the reduced image data S20 in the memory 22 (step ST12). Then, when the sub-sampling section 20 determines that the processing (scanning) has been completed for the decoded image data S18 for one screen, the reduction processing is terminated, or, when the processing has not been completed, program control is returned to step ST11 (step ST13).

The controller 24 reads, from the memory 22, the image data D_out to be displayed, and outputs the image data D_out to the display section 5. Then, an image having the size “Dst_ha×Dst_w” or “Dst_h×Dst_wa” (vertical×horizontal) obtained by reducing the image data D_in is displayed on the display section 5.

As is described above, according to the image processing apparatus 11, when the original image data are displayed in a reduced size, the decoded image data S18 are not stored in the memory 22, instead, the sub-sampling section 20 selects (extracts) the valid pixel data as the reduced image data S20 and stores them in the memory 22. Therefore, compared with the related case, the capacity required for the memory 22 is small, and the size and the cost can be reduced.

For example, when the size of the image data D_in to be decoded is 960×1280 pixels, and the display size of the display section 5 is 240×320 pixels, the sizes of the reduced image data S20 and the image data D_out to be displayed are 240×320 pixels. Thus, the memory need only have sufficient capacity to store image data for 240×320 pixels.

Furthermore, according to the image processing apparatus 11, while the aspect ratio of the input image data D_in is unchanged, the image is displayed in the display size with at least either the vertical or the horizontal length being fully used. Therefore, an image can be displayed in as large a size as possible, and at the same aspect ratio as that of the original image.

The present invention is not limited to the above embodiment.

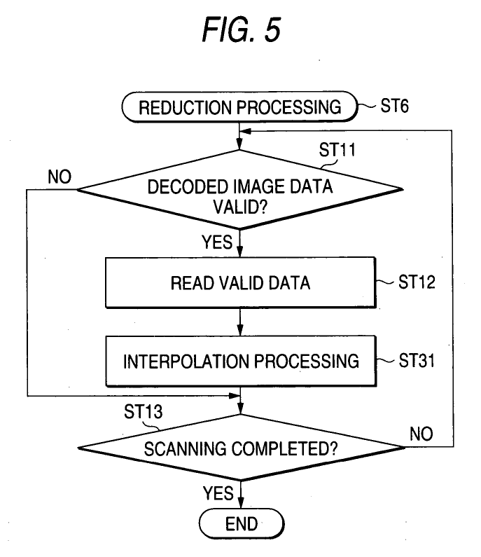

The processing at step ST6 in FIG. 3 for the embodiment may be performed during the processing shown in FIG. 5.

Specifically, at steps ST11 and ST12 in FIG. 5, the sub-sampling section 20 may extract not only valid pixel data but also pixel data near the valid pixel data, and may also perform an interpolation processing using the valid pixel data and the pixel data near the valid pixel data (step ST31).

So long as this interpolation processing is performed, a conventional interpolation method, whereby all the decoded data are temporarily stored in the memory and an interpolation processing is performed, can also be applied for the present invention.

The interpolation method can, for example, be a bi-linear method, a bi-cubic method, or an area average method.

Using this processing, the quality of the image displayed on the display section 5 can be further improved.

Further, in the embodiment, the reduced frame calculator 12, the Huffman decoder 14, the inverse quantization section 16, the inverse DCT section 18, and the sub-sampling section 20 have been provided by electronic circuits. However, all or part of these functions may be provided by a program.

The embodiment can be employed for a system that adjusts the size of image data after being decoded, and displays the image data having the adjusted size.

1. An image processing apparatus, comprising:
a calculation section which calculates a reduced size of an image to be decoded, based on an image size of the image to be decoded and an altered image size for displaying in a reduced size;
a decoding section which decodes image data of the image to be decoded to generate decoded image data;
a memory which stores display image data; and
a reduction section which extracts only pixel data required for displaying in the reduced size from the decoded image data generated by the decoding section, based on the calculated reduced size, and writes the extracted pixel data to the memory.

2. The image processing apparatus according to claim 1,
wherein the calculation section calculates the reduced size so that the image to be decoded is displayed in the reduced size with maintaining an aspect ratio of the image to be decoded.

3. The image processing apparatus according to claim 1,
wherein the reduction section extracts valid pixels and pixels near the valid pixels from the pixel data composing the decoded image data, performs an interpolation processing for the extracted pixels, and writes the resultant pixels to the memory.

4. A display device, comprising:
a calculation section which calculates a reduced size of an image to be decoded, based on an image size of the image to be decoded and an altered image size for displaying in a reduced size;
a decoding section which decodes image data of the image to be decoded to generate decoded image data;
a memory which stores display image data;
a reduction section, which extracts only those pixel data required for displaying in the reduced size from the decoded image data generated by the decoding section, based on the calculated reduced size, and writes the extracted pixel data to the memory; and
a display section which displays an image based on the pixel data written to the memory.

5. An image processing method, comprising the steps of:
calculating a reduced size of an image to be decoded, based on an image size of the image to be decoded and an altered image size for displaying in a reduced size;
decoding image data of the image to be decoded to generate decoded image data; and
extracting only pixel data required for displaying in the reduced size from the decoded image data, based on the calculated reduced size, and writing the extracted pixel data to a memory.

6. An image processing program, causing a computer to perform:
a function of calculating a reduced size of an image to be decoded, based on an image size of the image to be decoded and an altered image size for displaying in a reduced size;
a function of decoding image data of the image to be decoded to generate decoded image data; and
a function of extracting only pixel data required for displaying in the reduced size from the decoded image-data, based on the calculated reduced size, and writing the extracted pixel data to a memory.
